(19) United States
(12) Patent Application Publication
(10) Pub. No.: US 2018/0147768 A1
(43) Pub. Date: May 31, 2018

(54) MOLDING MEMBER SHAPE CONTROL DEVICE

(71) Applicant: TOYO TIRE & RUBBER CO., LTD., Itami-shi (JP)

(72) Inventors: Shuhei Ito, Itami-shi (JP); Makoto Komo, Itami-shi (JP)

(73) Assignee: TOYO TIRE & RUBBER CO., LTD., Itami-shi (JP)

(21) Appl. No.: 15/813,588

(22) Filed: Nov. 15, 2017

(30) Foreign Application Priority Data
Nov. 30, 2016 (JP) 2016-233020

(51) Int. Cl. B29C 47/12; B29C 43/58; B29C 47/70

(52) U.S. Cl. CPC B29C 47/122; G01L 5/0028; B29C 47/702; B29C 43/58

(57) ABSTRACT

A molding member shape control device includes: a flowable molding material flow passage; a flow resistance member advancing into and withdrawing from the flowable molding material flow passage; a sensor measuring a speed of a molding member formed by extruding a molding material from the flowable molding material flow passage; and a control unit advancing and withdrawing the flow resistance member on the basis of a difference between a speed of the molding member measured by the sensor and a target speed of the molding member at a position of the sensor.

### REFERENCE TO RELATED APPLICATIONS

The present application claims priority from Japanese patent application No. JP 2016-233020, filed on Nov. 30, 2016, the content of which is hereby incorporated by reference into this application. This application contains the entire contents of the same application with reference to JP 2016-233020.

### BACKGROUND OF THE INVENTION

### Field of the Invention

The present invention relates to a molding member shape control device.

### Description of the Related Art

In extrusion molding of a flowable molding material such as rubber or synthetic resin, a molding member formed by extruding the molding material needs to be straight. However, there is a case in which the molding member is curved due to an asymmetric shape of an extrusion port of an extruder. On the contrary, there is a case in which the molding member needs to be curved at a predetermined curvature.

Here, JP-A-2011-183750 discloses an invention in which a molding die is provided between an extruder body and a mouthpiece. A nest is provided inside the molding die and the nest is provided with a plurality of rubber flow passages connected from the extruder body to the mouthpiece. Then, each flow passage has a partially different inner diameter. Since the flow rate of the rubber becomes larger as the inner diameter becomes larger, a rubber molded product extruded from the mouthpiece is curved so that the flow passage side having a large inner diameter becomes an outer diameter side and the flow passage side having a small inner diameter becomes an inner diameter side.

Further, JP-A-2014-172250 proposes an invention in which a die is provided at a discharge port of an extruder body and a mouthpiece is provided at a discharge port of the die. In this invention, an attachment position of the mouthpiece with respect to the die is changeable. Depending on the attachment position of the mouthpiece with respect to the die, a portion directly receiving the rubber discharged from the die and a portion not directly receiving the rubber are generated at a rubber receiving port of the mouthpiece, so that a difference in flow velocity of the rubber occurs between these portions. As a result, the rubber extruded from the mouthpiece is curved at a predetermined curvature.

### SUMMARY OF THE INVENTION

However, in the invention disclosed in JP-A-2011-183750, the operator needs to replace the nest by separating the mouthpiece and the molding die from the extruder body at the time of changing the curvature of the rubber molded product. Further, in the invention disclosed in JP-A-2014-172250, the operator needs to change the attachment position of the mouthpiece with respect to the die at the time of changing the curvature of the extruded rubber molded product. In this way, when the mouthpiece is separated from the extruder body or the attachment position of the mouthpiece is changed, the operator feels troublesome.

Further, there is a case in which the curved shape of the molding member is different from the target curved shape when the extrusion is performed while the mouthpiece is attached to the extruder body. In such a case, the operator needs to separate the mouthpiece from the extruder body or change the attachment position of the mouthpiece again in order to correct the curved shape. As a result, the operator feels troublesome.

The invention has been made in view of the above-described circumstances and an object of the invention is to provide a molding member shape control device capable of independently correcting a curved shape of a molding member.

A molding member shape control device of an embodiment is a molding member shape control device including: a flowable molding material flow passage; a flow resistance member advancing into and withdrawing from the flowable molding material flow passage; a sensor measuring a speed of a molding member formed by extruding a molding material from the flowable molding material flow passage; and a control unit advancing and withdrawing the flow resistance member on the basis of a difference between a speed of the molding member measured by the sensor and a target speed of the molding member at a position of the sensor.

The molding member shape control device of the embodiment can independently correct the curved shape of the molding member.

### BRIEF DESCRIPTION OF THE DRAWINGS

FIG. 1 is a cross-sectional view showing an extruder 1 in the longitudinal direction.

FIG. 2 is a perspective view showing a mouthpiece 30 of which an extrusion port 33 has a bead filler shape when viewed from the extrusion port 33.

FIG. 3 is a cross-sectional view taken along a line A-A of FIG. 2 (a structure in which a flow resistance member 40 is fixed to a front end of a bolt 36).

FIG. 4 is a cross-sectional view taken along a line A-A of FIG. 2 (a structure in which a flow resistance member 40 is fixed to a front end of a bar 42).

FIGS. 5A to 5F are diagrams showing a variation of the flow resistance member 40, where FIG. 5A is a perspective view showing a columnar flow resistance member 40 when viewed from a flow passage 32, FIG. 5B is a perspective view showing a square pillar flow resistance member 40 when viewed from the flow passage 32, FIG. 5C is a perspective view showing a columnar flow resistance member 40 having a chamfered corner when viewed from the flow passage 32, FIG. 5D is a perspective view showing a conical flow resistance member 40 when viewed from the flow passage 32, FIG. 5E is a perspective view showing a state where a conical flow resistance member 40 is accommodated in an accommodation hole 34 when viewed from the flow passage 32, and FIG. 5F is a perspective view showing a state where a columnar flow resistance member 40 having a chamfered corner is accommodated in the accommodation hole 34 when viewed from the flow passage 32.

FIGS. 6A and 6B are diagrams showing a surface on which the flow resistance members 40 are arranged when viewed from the flow passage 32 of the molding material, where FIG. 6A is a diagram showing a state where the flow resistance members 40 are arranged in two rows and FIG. 6B is a diagram showing a state where the flow resistance members 40 are arranged in one row.

FIGS. 7A to 7C are diagrams showing a state where a molding member is extruded from the mouthpiece 30, where FIG. 7A is a diagram showing a state where the flow resistance members 40 do not advance into the flow passages 32, FIG. 7B is a diagram showing a state where a small number of the flow resistance members 40 slightly advance into the flow passages, and FIG. 7C is a diagram showing a state where a large number of the flow resistance members 40 compared to the case of 7B largely advance into the flow passages compared to the case of FIG. 7B.

FIGS. 8A and 8B are diagrams showing a state where a molding member is extruded from a mouthpiece 130, where FIG. 8A is a diagram showing a state where the flow resistance members 40 do not advance into flow passages 132 and FIG. 8B is a diagram showing a state where a part of the flow resistance members 40 advance into the flow passages 132.

FIGS. 9A and 9B are diagrams showing a state where a molding member is extruded from a mouthpiece 230, where FIG. 9A is a diagram showing a state where the flow resistance members 40 do not advance into flow passages 232 and FIG. 9B is a diagram showing a state where a part of the flow resistance members 40 advance into the flow passages 232.

FIG. 10A is a cross-sectional view at a center position of a mouthpiece 330 in the vertical direction and is a diagram showing a lower surface 238 of a flow passage 332 of the mouthpiece 330 when viewed from above, FIG. 10B is a cross-sectional view showing the mouthpiece 330 in the longitudinal direction at a position B-B of FIG. 10A, and FIG. 10C is a cross-sectional view showing the mouthpiece 330 in the longitudinal direction at a position C-C of FIG. 10A.

FIG. 11 is a cross-sectional view showing a mouthpiece in the horizontal direction in which the flow resistance members 40 are arranged in the horizontal direction of the flow passage 32 without a gap.

FIG. 12 is a cross-sectional view showing a mouthpiece 530 including a main body 530a and a separate body 530b in the longitudinal direction.

FIGS. 13A and 13B are diagrams showing a mouthpiece including a first flow resistance member 640 and a second flow resistance member 642, where FIG. 13A is a cross-sectional view in the horizontal direction and FIG. 13B is a cross-sectional view in the longitudinal direction.

FIG. 14 is a longitudinal cross-sectional view showing an extruder 701 including a shape control device 760.

FIG. 15 is a diagram showing a drive device 770 and the vicinity thereof.

FIG. 16 is a diagram showing a flow passage 32, a drive device 770 and a sensor 766 when viewed from a front side.

FIG. 17 is a flowchart showing a control of a control unit 762.

### DETAILED DESCRIPTION OF THE INVENTION

1. Molding Material Flow Passage and Flow Resistance Member

In this embodiment, rubber is exemplified as a flowable molding material and a flow passage of a mouthpiece for a rubber extruder is exemplified as a molding material flow passage.

An extruder 1 and its mouthpiece 30 according to the embodiment will be described with reference to the drawings. Further, the embodiment is an example and does not limit the scope of the invention. In the following description, a front side indicates an extrusion direction and a rear side indicates a direction opposite to the extrusion direction. A horizontal direction indicates a horizontal direction when a mouthpiece 30 is viewed from a front side of the mouthpiece 30. Unless otherwise specified, an arrow in the drawing indicates a flow direction of a molding material or a movement direction of a molding member 50.

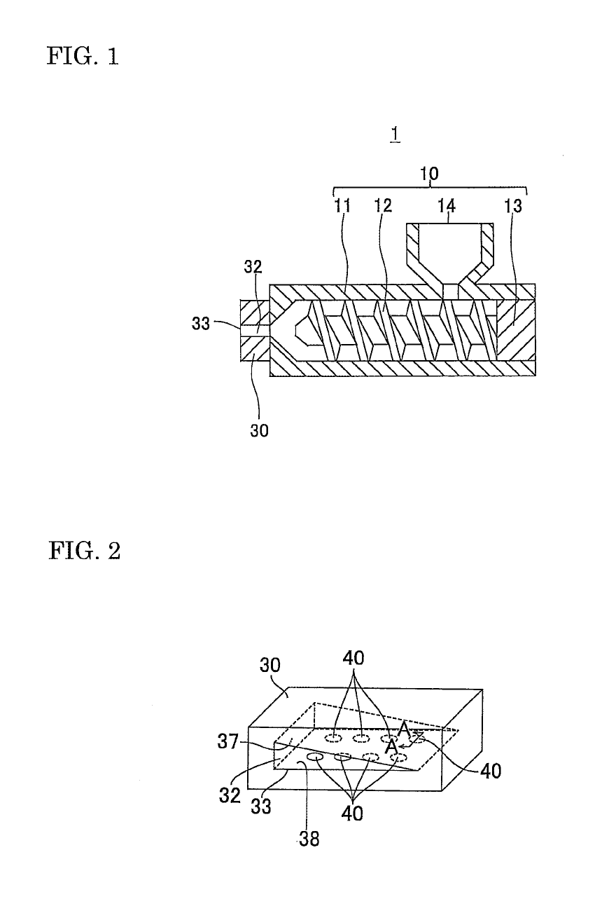

The extruder 1 of the embodiment is used to extrude a flowable molding material such as rubber or synthetic resin. As shown in FIG. 1, the extruder 1 includes an extruder body 10 and the mouthpiece 30 provided at a front end of the extruder body 10 in the extrusion direction.

The extruder body 10 includes a cylindrical barrel 11 which is placed sideways. A hopper 14 into which the molding material is input is connected to an upper portion of the barrel 11. A screw 12 is accommodated inside the barrel 11 along the center axis of the barrel 11. When a motor 13 provided at the rear side of the barrel 11 is driven, the screw 12 rotates to extrude the molding material input from the hopper 14 forward. A temperature of the barrel 11 can be adjusted by a heater (not shown).

In addition, a gear pump may be provided at a position in front of the screw 12 of the extruder body 10. The gear pump sends the molding material forward while adjusting a delivery amount. Further, a structure in which a piston is provided instead of the screw 12 and the piston extrudes the molding material forward may be employed.

The mouthpiece 30 includes a flow passage 32 penetrating the mouthpiece in the longitudinal direction. The molding material flows forward inside the flow passage 32. A front end of the flow passage 32 is an extrusion port 33.

A cross-sectional shape (a cross-sectional shape of the flow passage is a shape of a cross-section orthogonal to the molding material flow direction) of the flow passage 32 and a shape of the extrusion port 33 are not limited. In the case of the embodiment of FIG. 2, the cross-sectional shape of the flow passage 32 and the shape of the extrusion port 33 have an elongated shape in the horizontal direction, more specifically, a cross-sectional shape of a bead filler of a tire placed sideways. For that reason, the flow passage 32 is high in the vertical direction at one side of the horizontal direction (the left side of FIG. 2) and is low in the vertical direction at the other side (the right side of FIG. 2).

The mouthpiece 30 is provided with one or plural flow resistance members 40 which can advance into the flow passage 32. The flow resistance member 40 is a member that causes a resistance with respect to the flow of the molding material when the flow resistance member advances into the flow passage 32 and is, for example, a columnar member. An installation position of the flow resistance member 40 is not limited and, for example, is any one of an upper surface 37 and a lower surface 38 which are opposite close surfaces of the flow passage 32 when the cross-section of the flow passage 32 has an elongated hole shape as shown in FIG. 2. In FIG. 2, the flow resistance member 40 is provided at the lower surface 38.

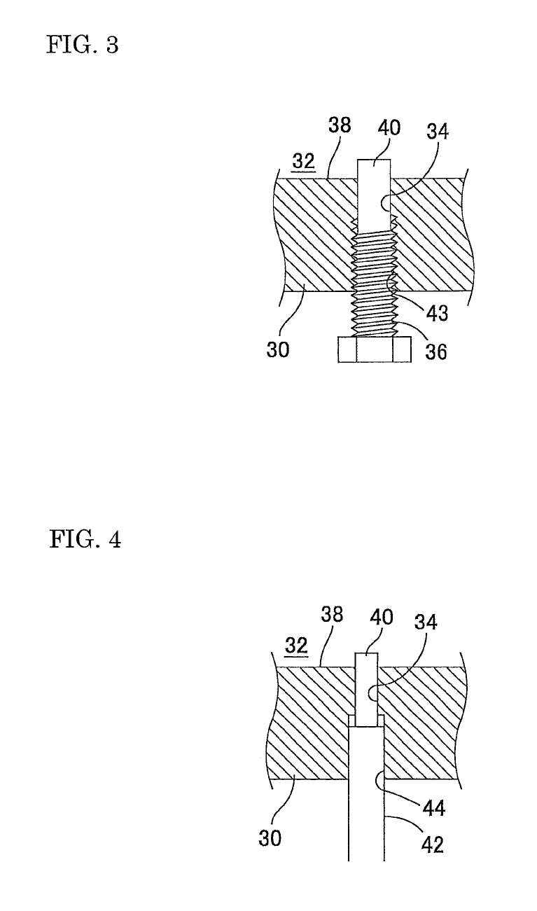

The flow resistance member 40 can advance into and withdraw from the flow passage 32 by the operation at the outside of the mouthpiece 30. A structure involving with the advancing and the withdrawing of the flow resistance member 40 is not limited. In the case of FIG. 3, an accommodation hole 34 having the same shape as the flow resistance member 40 is formed as a concave portion with respect to the lower surface 38 of the flow passage 32 of the mouthpiece 30 and a bolt hole 43 is formed from a bottom portion of the accommodation hole 34 to the outside of the mouthpiece 30. A bolt 36 passes through the bolt hole 43 and the flow resistance member 40 is fixed to a front end of the bolt 36. In this structure, when an operator rotates the bolt 36 in a direction in which the bolt is threaded into the mouthpiece 30, the flow resistance member 40 advances into the flow passage 32. Meanwhile, when the operator rotates the bolt in the opposite direction, the flow resistance member 40 withdraws from the flow passage 32. The operator can adjust the amount of the flow resistance member 40 advancing into the flow passage 32 by adjusting a threaded amount of the bolt 36. When the flow resistance member 40 completely withdraws, it is desirable that a top portion of the flow resistance member 40 be flush with a surface (in the case of FIG. 2, the lower surface 38) forming the flow passage 32.

In addition, a structure of FIG. 4 is exemplified as a different structure involving with the advancing and the withdrawing of the flow resistance member 40. In the case of FIG. 4, an accommodation hole 34 having the same shape as the flow resistance member 40 is formed as a concave portion with respect to the lower surface 38 of the flow passage 32 of the mouthpiece 30 and a penetration hole 44 is formed from a bottom portion of the accommodation hole 34 to the outside of the mouthpiece 30. A bar 42 passes through the penetration hole 44 and the flow resistance member 40 is fixed to a front end of the bar 42. In this structure, when an operation portion such as a cylinder moved by the operator or the instruction of the operator presses or pulls the bar 42 from the outside of the mouthpiece 30, the advancing amount of the flow resistance member 40 into the flow passage 32 can be adjusted.

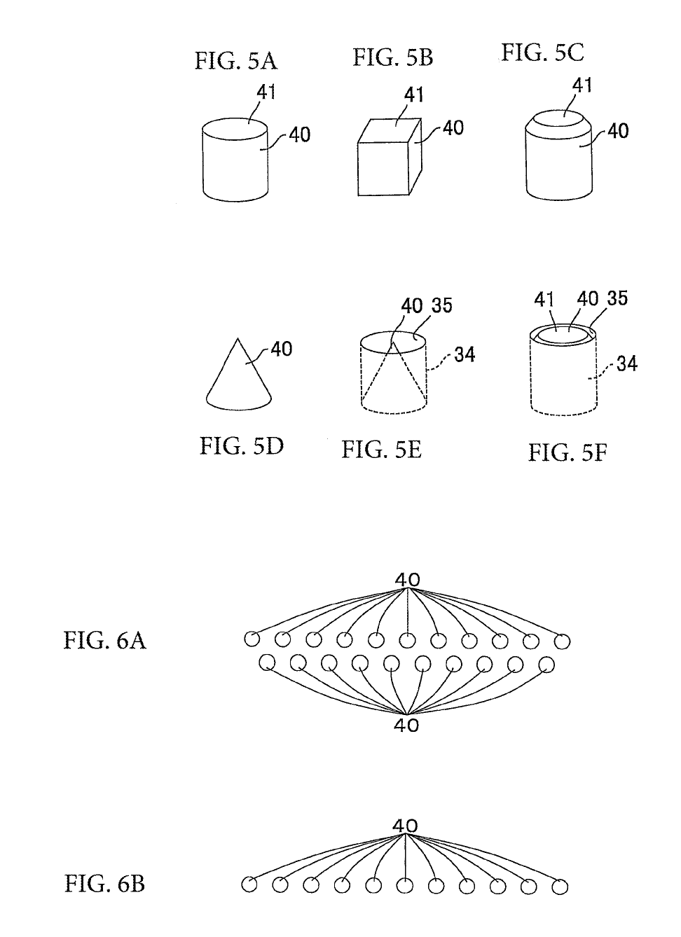

The flow resistance member 40 may be a columnar member shown in FIG. 5A, but may be a square pillar member shown in FIG. 5B, a columnar member having a chamfered corner shown in FIG. 5C, or a conical member shown in FIG. 5D. Among these, a top portion 41 of the flow resistance member 40 is desirably a surface as shown in FIGS. 5A to 5C from such a viewpoint that a large gap (for example, a gap 35 of FIG. 5E) does not exist between the accommodation hole 34 and the flow resistance member 40 when the flow resistance member 40 does not advance into the flow passage 32. Further, from such a viewpoint that a small gap (for example, a gap 35 of FIG. 5F) does not exist between the accommodation hole 34 and the flow resistance member 40, it is desirable that the top portion 41 of the flow resistance member 40 is one surface as shown in FIGS. 5A and 5B and it is desirable to form one surface by integrating the top portion 41 with the lower surface 38 corresponding to the surface of forming the flow passage 32 when the flow resistance member 40 does not advance into the flow passage 32.

A method of arranging the flow resistance members 40 is not limited. For example, the flow resistance members 40 may be arranged in two rows with a gap therebetween as shown in FIGS. 2 and 6A and the flow resistance members 40 may be arranged in one row with a gap therebetween as shown in FIG. 6B. When the flow resistance members 40 are arranged in two rows with a gap therebetween, it is desirable that the flow resistance member 40 of the first row and the flow resistance member 40 of the second row are alternately arranged as shown in FIG. 6A. Further, the flow resistance member 40 may be disposed at each of the left and right sides of the flow passage 32 or only one flow resistance member 40 may be provided at the flow passage 32.

When the flow resistance member 40 advances into the flow passage 32 in the mouthpiece 30, the advancing flow resistance member 40 serves as a resistance with respect to the flow of the molding material and the flow velocity and the flow rate of the molding material in the periphery of the flow resistance member 40 decrease. Accordingly, a curved shape of the molding member 50 extruded from the extrusion port 33 of the mouthpiece 30 changes. A detailed case will be described by exemplifying the mouthpiece 30 of FIG. 2.

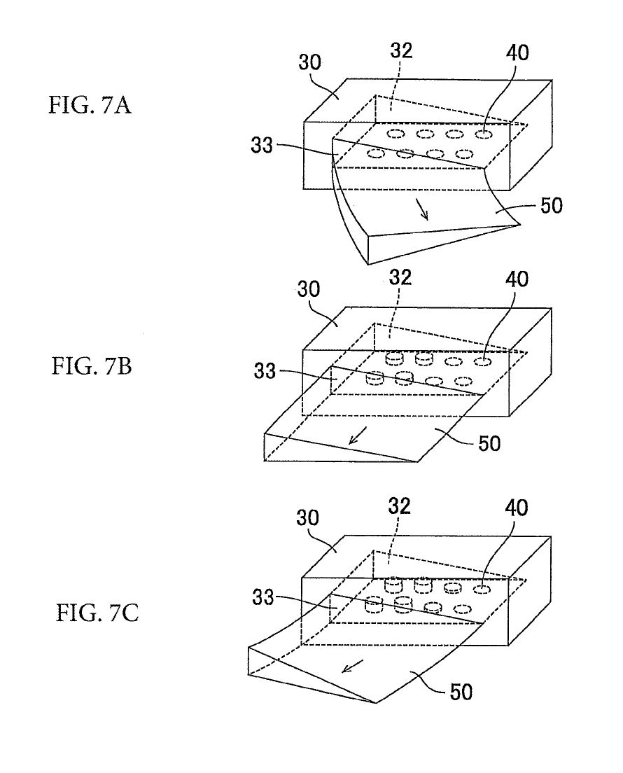

First, since the flow passage 32 is high at the left side and is low at the right side in the mouthpiece 30 of FIG. 2, the flow velocity and the flow rate of the molding material are large at the left side and are small at the right side when the flow resistance member 40 does not advance into the flow passage 32. For that reason, as shown in FIG. 7A, the molding member 50 extruded from the extrusion port 33 of the mouthpiece 30 is curved rightward.

Next, when a small number of the flow resistance members 40 at the left side slightly advance into the flow passages 32, the flow velocity and the flow rate at the left side inside the flow passage 32 are smaller than the case of FIG. 7A and the flow velocity and the flow rate of the molding material are the same in the horizontal direction. For that reason, as shown in FIG. 7B, the molding member 50 extruded from the extrusion port 33 of the mouthpiece 30 becomes straight.

Next, when the number of the left flow resistance members 40 advancing into the flow passage 32 increases or the advancing amount of the flow resistance member 40 increases compared to the case of FIG. 7B, the flow velocity and the flow rate at the left side inside the flow passage 32 are smaller than the case of FIG. 7B so that the flow velocity and the flow rate of the molding material are small at the left aide and are large at the right side. For that reason, as shown in FIG. 7C, the molding member 50 extruded from the extrusion port 33 of the mouthpiece 30 is curved leftward.

Since the shape of the extrusion port 33 does not change in any one of FIGS. 7A to 7C, a cross-sectional shape of the molding member 50 extruded from the extrusion port 33 is the same (a cross-sectional shape of the molding member is a shape of a cross-section in a direction orthogonal to the molding member extension direction). The size of the curvature of the molding member 50 when the molding member 50 is curved is changed in accordance with the advancing amount and the number of the flow resistance member 40 advancing into the flow passage 32.

In this way, since the flow resistance member 40 can advance into and withdraw from the flow passage 32 in the mouthpiece 30 of the embodiment, the curved shape of the molding member 50 can be changed. Further, since the advancing and the withdrawing of the flow resistance member 40 into and from the flow passage 32 are performed by the operation at the outside of the mouthpiece 30, the curved shape of the molding member 50 can be changed even when the operator does not separate the mouthpiece 30 from the extruder body 10 or does not change the attachment position of the mouthpiece 30.

Here, when there are many flow resistance members 40 provided in the mouthpiece 30, various methods of advancing the flow resistance member 40 are obtained. Accordingly, since it is possible to finely adjust the flow velocity and the flow rate of the molding material in accordance with the position inside the flow passage 32, it is possible to finely adjust the curved shape of the molding member 50. Further, when the flow resistance members 40 are arranged in two rows with a gap therebetween and the flow resistance members 40 at the first row and the flow resistance members 40 at the second row are alternately arranged, it is possible to extremely decrease the flow velocity and the flow rate of the molding material inside the flow passage 32 by advancing the flow resistance members 40 at both first and second rows and thus to largely change the curved shape of the molding member 50.

The above-described embodiment can be modified into various forms without departing from the spirit of the invention.

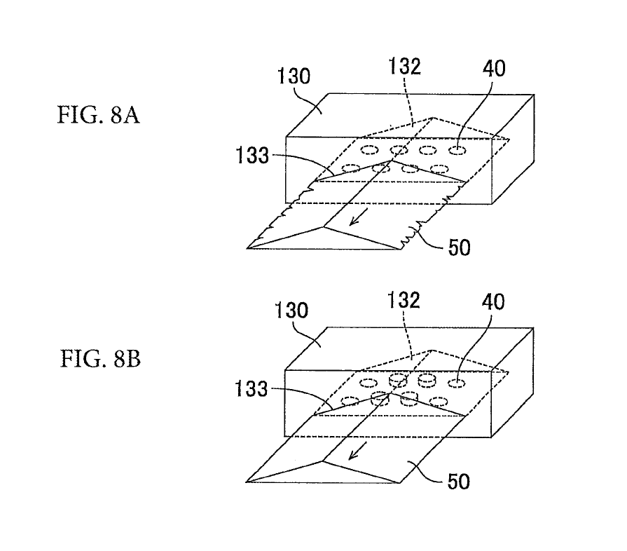

First, modified examples of the cross-sectional shape of the flow passage and the shape of the extrusion port are shown in FIGS. 8A to 10C. Further, it is assumed that the flow resistance members 40 are arranged in two rows in FIGS. 8A to 10C.

In a mouthpiece 130 of FIGS. 8A and 8B, a cross-sectional shape of a flow passage 132 and a shape of an extrusion port 133 have an elongated hole shape and have, more specifically, an isosceles triangle shape with an apex angle of 90° or more. In the mouthpiece 130, a lower surface which is one of opposite close surfaces of the flow passage 132 is provided with the flow resistance member 40 which can advance into and withdraw from the flow passage 132. A structure, a shape, and an arrangement involving with the advancing and the withdrawing of the flow resistance member 40 are the same as those of the above-described embodiment.

Since the flow velocity and the flow rate of the molding material are small at both left and right sides of the flow passage 132 when the flow resistance member 40 does not advance into the flow passage 132 of the mouthpiece 130 (FIG. 8A), both left and right sides of the molding member 50 extruded from the extrusion port 133 are easily cut. Here, when both left and right sides of the molding member 50 are cut, the flow resistance member 40 in the vicinity of the center of the flow passage 132 in the horizontal direction advances into the flow passage 132 (FIG. 8B). Then, the flow velocity and the flow rate of the molding material in the vicinity of the center of the flow passage 132 in the horizontal direction are small and the flow velocity and the flow rate of the molding material at both left and right sides of the flow passage 132 are large. As a result, both left and right sides of the molding member 50 extruded from the extrusion port 133 are not easily cut.

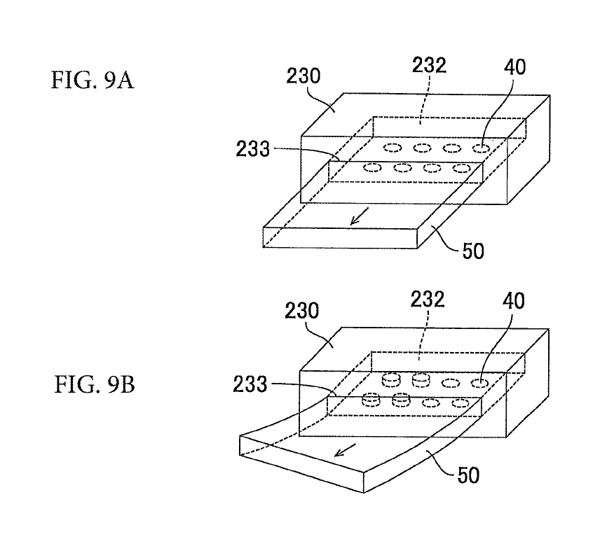

Further, in a mouthpiece 230 of FIGS. 9A and 9B, a flow passage 232 and an extrusion port 233 have an elongated hole shape and have, more specifically, a horizontal rectangular shape. For that reason, a height of the flow passage 232 in the vertical direction is the same at the left and right sides. In the mouthpiece 230, a lower surface which is one of opposite close surfaces of the flow passage 232 is provided with the flow resistance member 40 which can advance into and withdraw from the flow passage 232. A structure, a shape, and an arrangement involving with the advancing and the withdrawing of the flow resistance member 40 are the same as those of the above-described embodiment.

Since the flow velocity and the flow rate of the molding material are the same at the left and right sides inside the flow passage 232 when the flow resistance member 40 does not advance into the flow passage 232 of the mouthpiece 230 (FIG. 9A), the molding member 50 extruded from the extrusion port 233 straightly extends. However, when the flow resistance member 40 located at any one side of the flow passage 232 in the horizontal direction advances into the flow passage 232 (FIG. 9B), the flow velocity and the flow rate of the molding material in the vicinity of the advancing flow resistance member 40 are small so that the molding member 50 extruded from the extrusion port 233 is curved.

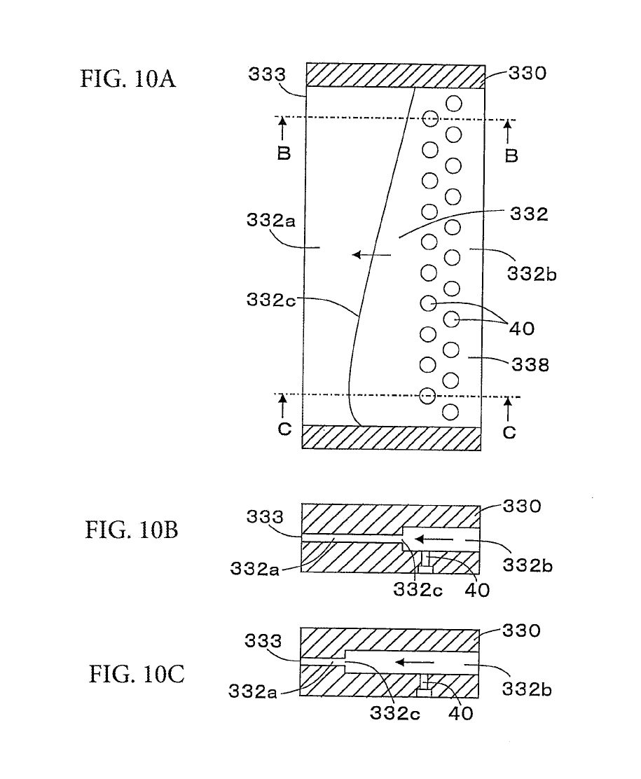

Further, in a mouthpiece 330 of FIGS. 10A to 10C, a flow passage 332 is formed to be narrow in the vertical direction at a front portion 332a near an extrusion port 333 and to be wide in the vertical direction at a rear portion 332b near the extruder body 10. The extrusion port 333 has a rectangular shape. A boundary 332c between the front portion 332a and the rear portion 332b is inclined with respect to the horizontal direction. For that reason, the rear portion 332b is formed to be long in the longitudinal direction (drawn as the horizontal direction in FIGS. 10A to 10C) at one side (for example, the right side (drawn as the lower side in FIGS. 10A to 10C)) of the left and right sides and to be short in the longitudinal direction at the other side (for example, the left side (drawn as the upper side in FIGS. 10A to 10C)).

In the mouthpiece 330, a lower surface 338 which is one of opposite near surfaces of the rear portion 332b of the flow passage 332 is provided with the flow resistance member 40 which can advance into and withdraw from the flow passage 332. A structure, a shape, and an arrangement involving with the advancing and the withdrawing of the flow resistance member 40 are the same as those of the above-described embodiment.

In the mouthpiece 330, since the rear portion 332b which is wide in the vertical direction is long in the longitudinal direction (drawn as the horizontal direction in FIGS. 10A to 10C) at one side (for example, the right side (drawn as the lower side in FIGS. 10A to 10C)) of the left and right sides and is short in the longitudinal direction at the other side (for example, the left side (drawn as the upper side in FIGS. 10A to 10C)), the flow velocity and the flow rate of the molding material are large at one side of the left and right sides inside the flow passage 332 and the flow velocity and the flow rate of the molding material are small at the other side when the flow resistance member 40 does not advance into the flow passage 332. For that reason, the molding member 50 extruded from the extrusion port 333 is curved.

Then, when the flow resistance member 40 advances into the flow passage 332, the curved shape of the molding member 50 extruded from the extrusion port 333 changes. For example, when the flow resistance member 40 at one side (for example, the right side (drawn as the lower side in FIGS. 10A to 10C)) of the left and right sides of the flow resistance members 40 advances into the flow passage 332, the flow velocity and the flow rate at one side inside the flow passage 332 are small and a difference in the flow velocity and the flow rate at the left and right sides is small. Accordingly, the curvature of the curved portion is small. Further, when the flow resistance member 40 at the other side (for example, the left side (drawn as the upper side in FIGS. 10A to 10C)) of the left and right sides of the flow resistance members 40 advances into the flow passage 332, the flow velocity and the flow rate at the other side inside the flow passage 332 are small and a difference in the flow velocity and the flow rate at the left and right sides is large. Accordingly, the curvature of the curved portion is large.

In addition, various shapes other than the elongated hole shape can be exemplified as the cross-sectional shape of the flow passage and the shape of the extrusion port. When the cross-sectional shape of the flow passage and the shape of the extrusion port are symmetrical in the vertical and horizontal directions and the flow resistance member does not exist inside the flow passage, the molding member can be curved by advancing the flow resistance member into the flow passage so that the flow velocity and the flow rate inside the flow passage become asymmetric in the vertical or horizontal direction even when the molding member is extruded straightly. Further, when the cross-sectional shape of the flow passage and the shape of the extrusion port are asymmetric in the vertical or horizontal direction and the flow resistance member does not exist inside the flow passage, the molding member can be extruded straightly by advancing the flow resistance member into the flow passage so that the flow velocity and the flow rate inside the flow passage become symmetrical in the vertical and horizontal directions even when the molding member is extruded in a curved state.

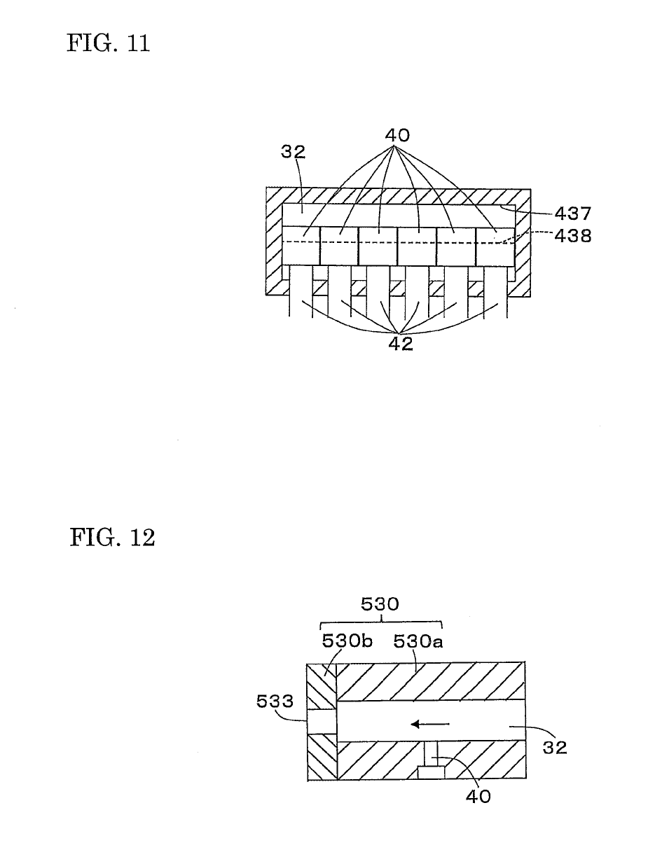

Further, as shown in FIG. 11, the flow resistance members 40 are arranged in the horizontal direction of the flow passage 32 without a gap and are advanced from a lower surface 438 to an upper surface 437 of the flow passage 32 while being pressed by the bar 42. In this case, when two or more continuous flow resistance members 40 advance from the lower surface 438 to the upper surface 437, a wall can be formed inside the flow passage 32 and the flow of the molding material can be stopped by the wall.

Further, as shown in FIG. 12, the mouthpiece 530 may include the main body 530a and the separate body 530b provided at the front side of the main body 530a. The separate body 530b is fixed to a front end of the main body 530a by a fixing member such as a bolt. The main body 530a is substantially the same as that of the mouthpiece of the above-described embodiments and modified examples and is provided with the flow resistance member 40 which can advance into and withdraw from the flow passage 32. The separate body 530b has a plate shape in which an extrusion port 533 is opened. A shape of the extrusion port 533 is the same as the final profile shape which is the cross-sectional shape of the extruded molding member.

According to this mouthpiece 530, the final profile shape can be changed just by replacing the separate body 530b. Then, since the advancing state of the flow resistance member 40 into the flow passage 32 changes when the separate body 530b is replaced, the flow of the molding material inside the flow passage 32 can be set to be suitable for the final profile shape at that time. For example, when the separate body 530b is replaced so that the final profile shape is changed from a rectangular shape shown in FIGS. 9A and 9B to an isosceles triangle shown in FIGS. 8A and 8B, the flow resistance member 40 located in the vicinity of the center in the horizontal direction and not advancing into the flow passage 32 is advanced into the flow passage 32 so that both left and right sides of the molding member 50 are not cut. Further, since there is no need to flow the molding material to the right side of the flow passage 32 when the extrusion port 533 is attached with the separate body 530b opened by the half of the left side of the flow passage 32 of the main body 530a, the right flow resistance member 40 is advanced into the flow passage 32 so that the flow of the molding material at the right side of the flow passage 32 is disturbed.

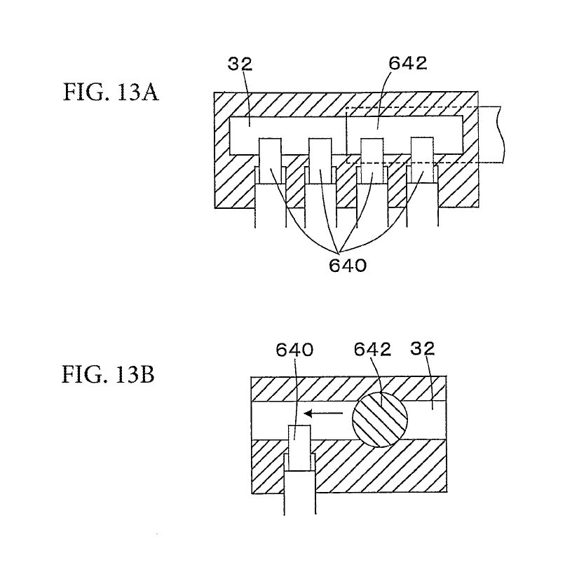

Further, as shown in FIGS. 13A and 13B, a plurality of first flow resistance members 640 may be provided in the horizontal direction to advance into and withdraw from the flow passage 32 in the vertical direction and second flow resistance members 642 may be provided at a position behind the first flow resistance members 640 inside the flow passage 32 to advance and withdraw in the horizontal direction. A thickness of the second flow resistance member 642 in the vertical direction is not limited, but in FIGS. 13A and 13B, a thickness of the second flow resistance member 642 in the vertical direction is longer than a height of the flow passage 32 in the vertical direction. In the case of FIGS. 13A and 13B, the flow of the molding material is completely stopped in a range in which the second flow resistance member 642 advances. The second flow resistance member 642 may be provided at any one of the left and right sides of the flow passage 32 or may be provided at both left and right sides.

2. Molding Member Shape Control Device

A shape control device 760 for the molding member 50 of the embodiment includes the flow resistance member 40 and uses the flow resistance member. In the embodiment, all embodiments and modified examples described in “1. Molding Material Flow Passage and Flow Resistance Member” can be used. In the description below, the shape of the flow resistance member 40, the arrangement of the flow resistance member 40, and the cross-sectional shape of the flow passage 32 are examples.

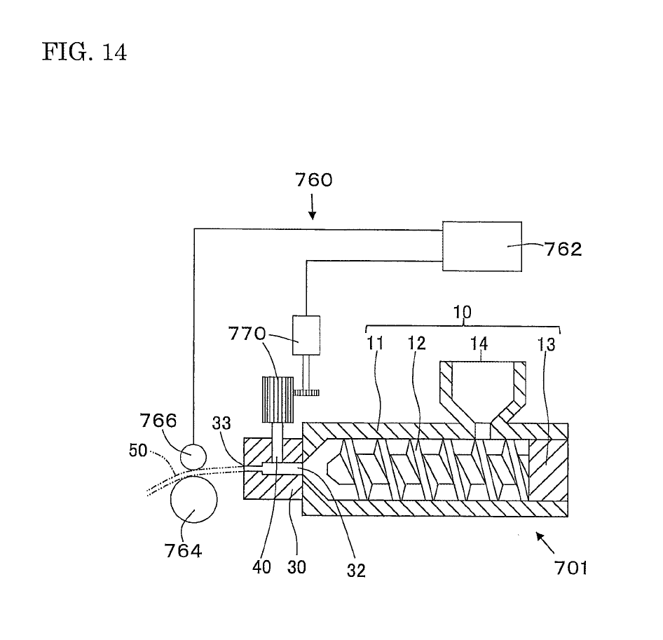

FIG. 14 shows a rubber extruder 701 including the shape control device 760 of the embodiment. Similarly to the extruder 1 of the above-described embodiment, the extruder 701 includes a rubber flow passage 32 inside the mouthpiece 30 and a flow resistance member 40 advancing into and withdrawing from the flow passage 32. Further, the extruder 701 includes a drive device 770 which advances and withdraws the flow resistance member 40 inside the flow passage 32 and a control unit 762 which advances and withdraws the flow resistance member 40 by driving the drive device 770. Furthermore, the extruder 701 includes a support portion 764 which is provided at the front side of the mouthpiece 30 and is a receiving roller supporting the molding member 50 extruded from the mouthpiece 30 below and a sensor 766 which is a rotary encoder measuring a speed of the molding member 50 supported by the support portion 764. The sensor 766 is electrically connected to the control unit 762 and transmits measured information to the control unit 762. The shape control device 760 includes the flow resistance member 40, the drive device 770, the control unit 762, and the sensor 766.

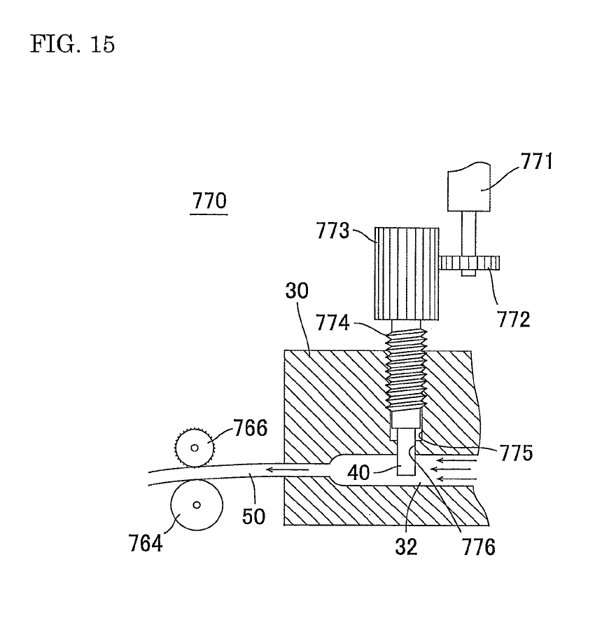

FIG. 15 shows the drive device 770. The drive device 770 includes a drive motor 771 which is driven by an instruction from the control unit 762, a first gear 772 which rotates by the driving of the drive motor 771, a second gear 773 which engages with the first gear 772, and a male thread portion 774 which is fixed to the second gear 773 and rotates to be coaxial with the second gear 773. The flow resistance member 40 is fixed to a front end of the male thread portion 774 and the male thread portion 774 and the flow resistance member 40 are coaxially rotatable. Further, the mouthpiece 30 is provided with a hole-shaped female thread portion 775 extending toward the flow passage 32 from the outside. A penetration hole 776 is formed from a bottom of the female thread portion 775 to the flow passage 32 so that the flow resistance member 40 can pass therethrough. Then, the male thread portion 774 fixed to the second gear 773 is threaded into the female thread portion 775 of the mouthpiece 30 and the flow resistance member 40 fixed to the front end of the male thread portion 774 penetrates the penetration hole 776 of the mouthpiece 30.

With this configuration, when the first gear 772 rotates by the driving of the drive motor 771 in accordance with an instruction from the control unit 762, the male thread portion 774 rotates along with the second gear 773 engaging with the first gear. Then, the second gear 773, the male thread portion 774, and the flow resistance member 40 move in the axial direction together. As a result, the flow resistance member 40 advances and withdraws inside the flow passage 32.

Here, the second gear 773 is sufficiently long in the axial direction so that the first gear 772 and the second gear 773 are not separated even when the flow resistance member 40 largely advances and withdraws inside the flow passage 32 so that the second gear 773 largely moves in the axial direction.

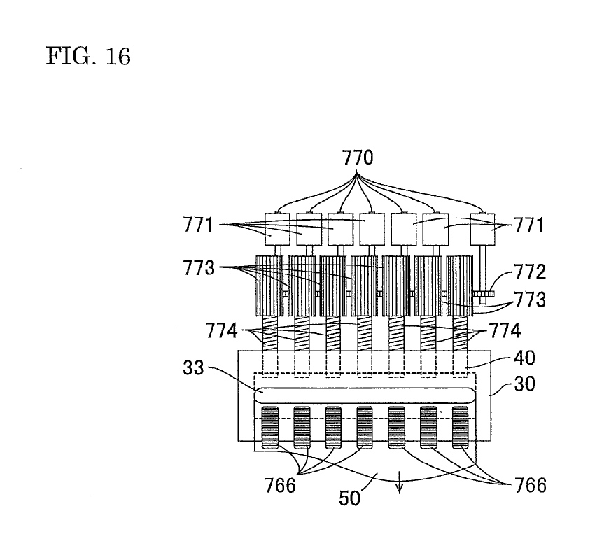

As shown in FIG. 16, when the flow resistance members 40 are provided, the drive device 770 is provided as many as the flow resistance member 40 so that one flow resistance member 40 is advanced and withdrawn by one drive device 770. Then, the flow resistance members 40 are respectively independently advanced and withdrawn by the driving of the drive devices 770.

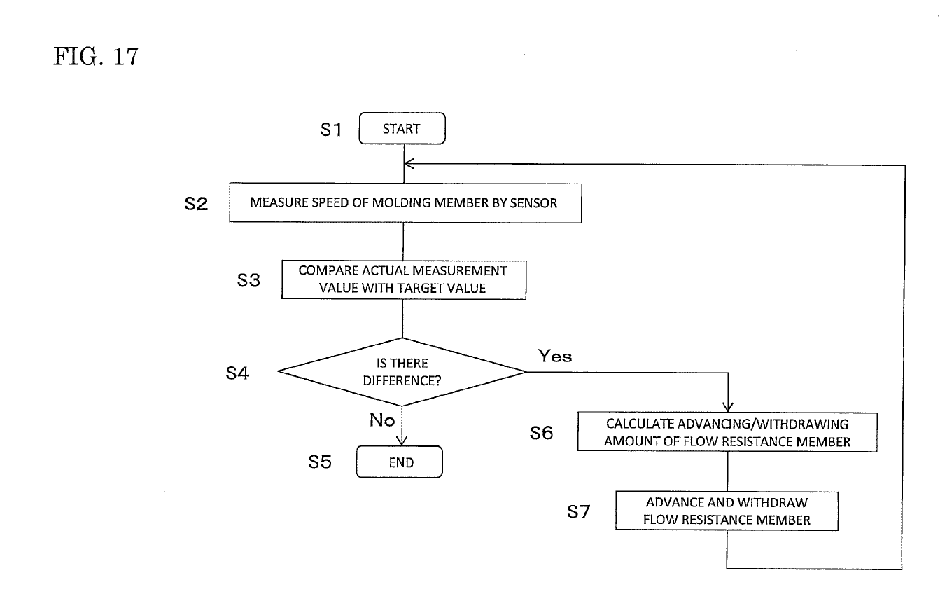

In such a shape control device 760, the control unit 762 advances and withdraws the flow resistance member 40 on the basis of a difference between the speed (the actual measurement value) of the molding member 50 measured by the sensor 766 and the target speed (the target value) of the molding member 50 at the position of the sensor 766. Here, the target value is a value in which the molding member 50 has an ideal curved shape when the speed of the molding member 50 measured by the sensor 766 becomes the target value. The control unit 762 advances and withdraws the flow resistance member 40 so that the actual measurement value approaches the target value and the curved shape of the molding member 50 approaches the ideal curved shape. The control method will be described with reference to FIG. 17. Here, as an example, the flow resistance members 40 are arranged in the horizontal direction, that is, the width direction of the molding member 50 and the sensor 766 is provided at each of the flow resistance members 40 as shown in FIG. 16.

In advance, the target speed of the molding member 50 extruded from the mouthpiece 30 at the position of each sensor 766 is set as the target value by the control unit 762. After the setting, the control unit 762 starts a control (S). First, the control unit 762 measures the speed of the molding member 50 at each position by each sensor 766 (S2). Next, the control unit 762 compares the target value with the actual measurement value of the molding member 50 at each position (S3). Then, when there is no difference between the actual measurement value and the target value at all positions (No of S4), the control unit 762 ends the control (S5). Meanwhile, when there is a difference between the actual measurement value and the target value at one or more positions (Yes of S4), the control unit 762 calculates the advancing/withdrawing amount of the flow resistance member 40 in order to match the actual measurement value and the target value at all positions (S6). The control unit 762 drives the drive motor 771 on the basis of the calculation result so as to advance and withdraw the flow resistance member 40 by the advancing/withdrawing distance (S7). The control unit 762 measures the speed of the molding member 50 at each position again by each sensor 766 after advancing and withdrawing the flow resistance member 40 (S2). The control unit 762 adjusts the advancing amount of the flow resistance member 40 by repeating the above-described control until the actual measurement value and the target value match each other at all positions. When the actual measurement value and the target value match each other at all positions (No of S4), the control unit 762 ends the control (S5). When the actual measurement value and the target value match each other at all positions, the molding member 50 has an ideal curved shape.

In addition, the target value may have a predetermined range. When the target value has a predetermined range, a case in which “no difference exists between the actual measurement value and the target value” and the “actual measurement value matches the target value” in the description above with reference to FIG. 17 mean that the actual measurement value falls into the range of the target value. Meanwhile, a case in which a “difference exists between the actual measurement value and the target value” means that the actual measurement value is out of the range of the target value.

During the operation of the extruder 701, the control unit 762 may repeatedly perform such a control shown in FIG. 17 without a time interval or may intermittently perform such a control with a predetermined time interval. Further, the control unit 762 may perform such a control shown in FIG. 17 only once during each operation of the extruder 701.

As described above, the shape control device 760 of the embodiment can independently correct the curved shape of the molding member 50 by advancing and withdrawing the flow resistance member 40 on the basis of a difference between the actual measurement value and the target value of the molding member 50. Here, when the sensors 766 and the flow resistance members 40 are arranged in the width direction of the molding member 50 as in the embodiment, the speed of the molding member 50 can be measured at a plurality of positions in the width direction. Accordingly, since the balance of the horizontal flow of the molding material inside the flow passage 32 can be finely adjusted by the advancing and the withdrawing of the flow resistance members 40 on the basis of the measurement result, the molding member 50 has a substantially ideal curved shape.

The above-described embodiment can be modified into various forms without departing from the spirit of the invention. For example, the number of the flow resistance members 40 may not be essentially the same as the number of the sensors 766. For example, the number of the sensors 766 may be small and the control unit 762 may use the measurement result obtained by one sensor 766 for the advancing and the withdrawing of the flow resistance members 40.

What is claimed is:

1. A molding member shape control device comprising:
a flowable molding material flow passage;
a flow resistance member advancing into and withdrawing from the flowable molding material flow passage;
a sensor measuring a speed of a molding member formed by extruding a molding material from the flowable molding material flow passage; and
a control unit advancing and withdrawing the flow resistance member on the basis of a difference between a speed of the molding member measured by the sensor and a target speed of the molding member at a position of the sensor.

2. The molding member shape control device according to claim 1,
wherein a plurality of the flow resistance members and a plurality of the sensors are respectively arranged in a width direction of the molding member.

3. The molding member shape control device according to claim 1,
wherein the control unit adjusts an advancing amount of the flow resistance member until the speed of the molding member measured by the sensor matches the target speed of the molding member at the position of the sensor.
